(19) United States
(12) Patent Application Publication
(10) Pub. No.: US 2008/0061919 A1
(43) Pub. Date: Mar. 13, 2008

(54) Insulators for transformers

(76) Inventors: Richard P. Marek, Chesterfield, VA (US); Jean-Pierre Jakob, Ballaison (FR); Giorgio Patrizio Vercesi, Gaillard (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/714,758

(22) Filed: Mar. 6, 2007

Related U.S. Application Data
(60) Provisional application No. 60/784,718, filed on Mar. 22, 2006.

(51) Int. Cl. H01F 27/32; H01B 3/18; H01F 41/00

(52) U.S. Cl. 336/207; 252/567; 29/602.1

(57) ABSTRACT

The invention provides discrete insulators for an electrical transformer, made of thermotropic liquid crystalline polymer (LCP).

### FIELD OF THE INVENTION

The invention relates to the field of electrical transformers, particularly insulators or spacers used in power and distribution transformers.

### BACKGROUND OF THE INVENTION

A transformer is a device for stepping-up, isolating or stepping-down, the voltage of an alternating electric signal and is widely used for transferring energy of an alternating current in the primary winding to that in one or more secondary windings.

The basic design of a transformer consists of two or more electrical circuits comprising primary and secondary windings, each made of multi-turn coils of conductors with one or more magnetic cores coupling the coils by transferring magnetic flux there between. Conventionally, in the core form construction, the two or more vertically arranged laminated steel core legs have two or more windings concentrically arranged around each core leg. In its simplest form, the windings are commonly separated into Low Voltage (LV) and High Voltage (HV) winding sections. In an alternate construction, the LV and HV coils are interleaved vertically for shell form construction. The coils are separated from each other by a dielectric (insulating) material.

It is known, for example, see U.S. published patent application no. 20040070480, U.S. Pat. Nos. 6,445,269 and 6,259,345, to make small transformers by encapsulating the conductor coils in a liquid crystalline polymer (LCP) as dielectric. However, encapsulation technology is not possible for transformers of large size, commonly designated as power and distribution transformers. For larger transformers, spacers in the form of axial sticks and radial spacers must be used to ensure and maintain effective cooling of the transformer coils, whether between layer windings or between the multiple winding sections. Vertically arranged sticks are often used as separators between coils and/or winding sections for layer type windings. When the windings are of the disc type, which term also encompasses the terms section, helix, and, in the shell form type, the term pancake, it is known to provide axial and radial spacing through appropriate use of axial spacers and/or radial (disc) spacers. In a typical core form set-up the radial spacers are discreet and secured onto the axial spacers along the height of the coil so as to maintain the radial spacers in place and thus provide desired dielectric distance between conductors and adequate flow of coolant fluid around the windings. Usually a fluid coolant medium such as oil, air, or gas is used. These radial spacers are typically glued to a sheet insulation called a washer in the shell form construction. In another typical set-up, the axial and radial spacers are combined to form a comb shaped configuration. Some examples of winding spacers are described, for example, in U.S. Pat. Nos. 1,159,770, 2,201,005, 2,756,397, and 2,783,441.

Dielectric elements in the form of vertical sticks, axial, and radial spacers, hereinafter called collectively spacers, must be made of electrically insulating material. The insulating material must have appropriate dielectric strength, and be able to withstand heat and fluctuations of temperature. In some transformers, the coils and insulating layers are immersed in fluid, which aids in transporting heat away from the coils, so the insulator material should ideally be resistant to the commonly used fluids. Also the spacers must be able to withstand the mechanical stresses developed during manufacturing and electrical/mechanical stresses during the operation of the transformer, such as, for example, during a short-circuit event.

In conventional transformers, the spacers are made of a variety of insulating materials depending on required temperature classes, design, cost, and other performance and property requirements. Commonly used materials include cellulose fibres, paper or board, ceramic materials, aramid fibres, paper or pressboard, and glass fibre-filled thermoset materials such as epoxy or polyester, where the glass can be in form of discontinuous short fibres, a glass mat, or a fabric

Cellulose insulation is a cost-effective insulation material, even with the significant labour required to prepare the parts. The parts are typically cut or sawn from large sheets, milled to a consistent thickness, milled on the edges to remove sharp corners that might tear wire insulation and then finally punched into individual parts. In the case of sticks, stacks of pre-cut strips must be glued together and then oven cured to build up the part to the proper thickness. Furthermore, the use of cellulose insulation is limited to relatively low temperature class transformers, with limited hot-spot capabilities, and operating temperature limits up to 105° C. continuous. A further limitation of cellulose board parts derives from its moisture absorption behaviour which, depending on ambient relative humidity, affects the dimensional stability and consistency of the parts. This in turn can develop severe difficulties in coil assembly operation where special care must be made to maintain the disc-to-disc distances as well as the total height of the winding assembly within the design specifications, which is critical to the ultimate characteristics and performance of the transformer. Ad-hoc adjustments during assembly of the windings are typical, to compensate for inconsistent spacers dimensions (for example in respect to the thickness of radial spacers in a disc wound assembly) and can lead to substantial increased time of assembly and, ultimately, costs. Furthermore, it is known that under long-term high-to-medium-temperature exposure, cellulose fibres are subject to hydrolytic degradation and age, which causes spacer shrinkage, resulting in loosening of the mechanical clamping structure, eventually leading to transformer failure under short-circuit conditions. A great deal of time is also spent in drying and adjusting windings, due to the moisture absorption tendency of the cellulose.

Glass fibre-filled epoxy or polyester insulation materials have better temperature performance (up to 155-180° C. for epoxy, up to 220° C. for polyesters), however, the presence of glass fibres, which is necessary to impart structural rigidity, shortens the life of the insulator and may precipitate partial discharges. Under repeated temperature cycling the difference in the thermal coefficients of expansion of glass and polymer can lead to the formation of voids in the part, resulting in partial discharges or corona effects, eventually leading to the breakdown of the insulator. Hence, such materials are more commonly found in dry type transformers, whereas in liquid filled transformers aramid and cellulose fibres are generally preferred, especially in HV winding sections. Furthermore, with thermoset materials, the shapes of spacer parts that can be made are limited, placing constraints on transformer design. Also, thermoset materials are not inherently flame resistant (UL 94-V0), and their use in dry type transformers requires extensive formulation by use of flame retardant additives.

Ceramic spacers are being less and less used in dry-type transformers, primarily because of the relatively high cost due to their manufacturing process, and their brittleness, which can cause frequent need for repair. The brittleness can cause cracking during the winding process, during assembly of the coils onto the core structure, and in the field during routine maintenance. Practical limitations also apply on the variety of available shapes.

Spacers made from pressboard or paper aramid fibres, such as Nomex®, can be used at high temperatures (up to 220° C. continuous) and present outstanding balance of thermo-chemical, mechanical, and electrical properties. However, the desired insulator shape must be cut out of a panel of pressboard, or stamped out of aramid paper sheets, resulting in significant handling and labour costs, and considerable waste of material in the non-used trimmings. All of these add to transformer cost.

In general, with all of the above described materials, the coil assemblies have to be designed to fit the shape/size of the spacers, A need remains for improved spacers for transformers.

### SUMMARY OF THE INVENTION

In a first aspect, the invention provides a discrete insulating spacer element, which is used to separate and maintain space between the conducting windings or coils of a transformer, wherein the spacer element is made of a liquid crystalline polymer (LCP).

In a second aspect, the invention provides an electrical transformer comprising:

electrical conducting coils for stepping up, isolating and/or stepping down voltage, and discrete insulating spacer elements separating and insulating the electrical coils, wherein the discrete spacer elements are made of a liquid crystalline polymer.

In a third aspect, the invention provides a process for making an insulating spacer element for an electrical transformer, comprising injection-moulding or extruding an LCP composition into the desired form.

In a fourth aspect, the invention provides a process for making an electrical transformer, comprising the step of:

inserting an insulating spacer made of LCP between coils of conducting wire.

### DETAILED DESCRIPTION OF PREFERRED EMBODIMENTS

### BRIEF DESCRIPTION OF THE DRAWINGS

FIG. 1 shows an electrical transformer constructed using the discrete spacer elements of the invention.

FIG. 2 shows a preferred embodiment of a discrete spacer element of the invention, with attachment means at two ends.

FIG. 3 shows a preferred embodiment of a discrete spacer element of the invention, with attachment means at one end.

The inventors have found that insulating spacers between coils of electrical transformers can be made of liquid crystal polymers (LCPs). In a preferred embodiment, the spacer is a modular form that can be used to build up a transformer of any desired size of shape, simply by increasing the number of coils and spacers. A transformer is made by forming coils, of the desired number of turns, with spacers of LCP between the coils. The spacers of the invention are separable from the coils. The method of building a transformer with the spacers of the invention is distinct from known methods of encapsulation with LCP. The spacers of the invention are discrete, detached or separate from the coils. In the encapsulation method, the wire coils must first be made, and then cast in molten polymer. Once the coils take on larger dimensions, as is the case with a high voltage transformer for long-range transmission, it is not possible to cast them in molten polymer. The method of the invention is not limited in this way. Transformers of essentially limitless size and capacity can be constructed.

Also contemplated are transformers in which some of the spacer elements are made of LCP (for example, in potential hotspots) and other spacer elements are made of conventional materials, such as cellulose, aramid, ceramic, or thermoset material.

The spacers of the present invention have inherently very low moisture absorption and moisture regain characteristics (<0.05% after 6 months immersion in water measured according to ASTM D570). This represents a significant advantage over cellulose spacers, in that spacers of the invention show excellent dimensional stability and consistency.

In another preferred embodiment of the method of making a transformer, the wire coils may be wrapped around the spacers made of LCP.

The spacers made of LCP have the advantage over glass fibre-filled epoxy or polyester insulators that the spacer does not require glass-fibre reinforcement. By avoiding glass-fibre reinforcement, faults leading to partial discharges are greatly minimized, meaning the spacers have a longer useful lifetime without discharges. Preferably the spacers of the invention do not comprise glass fibre.

Furthermore, LCP's are inherently fire-resistant. This means that spacers may be made without the addition of fire-retardants. Nevertheless, spacers comprising fire retardants are also within the scope of the invention.

The compositions described herein may be made and formed into the spacers by conventional methods used for mixing and forming thermoplastic compositions. The compositions may be made by melt mixing the LCP and any other low melting ingredients in a typical mixing apparatus such as a single or twin-screw extruder or a melt kneader. Parts may be formed by typical thermoplastic forming methods such as extrusion, extrusion coating, thermoforming, blow moulding, injection, sheet, or press moulding.

Preferred forming processes are injection moulding or extruding. Particularly preferred is injection moulding, because spacers of essentially any desired shape may be made, while avoiding waste, excessive handling, and significant labour costs. It is also possible to form a sheet of LCP and to cut the spacers from the sheet, for example, using a laser beam or a mechanical method of cutting such as a knife or saw. Any waste cuttings may be remelted and recycled.

The spacers of the invention may have any desired form, making it possible to design the transformer shape and size to fit the end use. The spacers may be designed to fit the coils, rather than the other way round. A preferred form for the spacers is sheets, which may have the shape, for example, of rectangles, squares, triangles, circles, ellipses, or irregular shapes. In addition, the spacers may take the form of rods or sticks. In one preferred embodiment, the spacers take the form of rods, which are then used to provide a framework for building up the coils of the transformer, by supporting the coils at the circumference of the coil, or in the middle of the coil. Such rod-like spacers may also support sheet-like spacers, which can be placed orthogonally to the rods, between the coils of the transformer.

The spacers of the invention may be hollow, partially hollow or solid, depending on the strength requirements of the particular spacer.

The LCP spacers of the invention may be used in air, gas, or oil-filled transformers, but are particularly suited to use in oil-filled transformers.

By a “liquid crystalline polymer” herein is meant a polymer that is anisotropic when tested using the TOT test or any reasonable variation thereof, as described in U.S. Pat. No. 4,118,372, which is hereby included by reference. Useful LCPs include polyesters. One preferred form of LCP is “all aromatic”, that is all of the groups in the polymer main chain are aromatic (except for the linking groups such as ester groups), but side groups which are not aromatic may be present. Preferably the melting point of the LCP is about 350° C. or higher, more preferably about 365° C. or higher, and especially preferably about 390° C. or higher. Melting points are measured by ASTM Method D3418. Melting points are taken as the maximum of the melting endotherm and are measured on the second heat at a heating rate of 10° C./min. If more than one melting point is present, the melting point of the polymer is taken as the highest of the melting points.

A preferred LCP is made from 4,4′-biphenol/1,4-dihydroxybenzene/1,4-benzenedicarboxylic acid/2,6-naphthalenedicarboxylic acid/4-hydroxybenzoic acid or derivatives thereof (50150188/121320 molar parts) and has a melting point of about 350° C. The molar parts of 1,4-benzenedicarboxylic acid/2,6-naphthalenedicarboxylic acid can also range from about 70/30 to about 90/10. A second preferred LCP is made from 1,4-dihydroxybenzene/1,4-benzenedicarboxylic acid/2,6-naphthalenedicarboxylic acid/4-hydroxybenzoic acid or derivatives thereof (100/5/95/100 molar parts) and has a melting point of about 350° C. The molar parts of 1,4-benzenedicarboxylic acid/2,6-naphthalenedicarboxylic acid can also range from about 5/95 to about 30/70 and the molar parts of 4-hydroxybenzoic acid can also range from about 100 to about 300.

Other materials, particularly those often found in or made for use in thermoplastic compositions may also be present in the composition. These materials should preferably be chemically inert and reasonably thermally stable under the operating environment of the moulded part in service, and/or during part formation. Such materials may include, for example, one or more of fillers, reinforcing agents, pigments, and nucleating agents. Other polymers may also be present, thus forming polymer blends. If other polymers are present, it is preferred that they are less than 25 weight percent of the composition. In another preferred type of composition, other polymers are not present except for a small total amount (less than 5 weight percent) of polymers such as lubricants and processing aids. In another preferred form, the composition contains about 1 to about 55 weight percent of fillers and/or reinforcing agents, more preferably about 5 to about 40 weight percent of these materials. Reinforcing agents and/or fillers include glass filler, fibrous materials such as meta- or para-aramid fibres and particulates (pulp, fibrids, powder), wollastonite, titanium dioxide whiskers, and powders (particulates) such as mica, clays, calcium sulphate, calcium phosphate, barium sulphate, and talc. Some of these materials may act to improve the strength and/or modulus of the composition and/or may improve the flammability resistance (see for instance WO02/02717, which is hereby included by reference).

Preferred fillers/reinforcing agents include talc.

Although glass fillers are not used in a preferred embodiment of this invention, due to their propensity to accelerate the formation of faults leading to partial discharges, their use may be advantageous to reach specific requirements, for example, mechanical strength of the part. By “glass filler” herein is meant any relatively small particle or fibrous glass material suitable for mixing into a thermoplastic. Useful glass materials include so-called “E-glass”, “S-glass”, soda lime glass, and borosilicate glass. This filler may be in any form, such as fibre (fibreglass), milled glass (ground glass fibre), glass flake, hollow, or solid spheres.

All percents by weight herein are based on the total composition containing the LCP and filler, unless otherwise stated.

Preferably the amount of LCP in the composition is at least about 35 weight percent, more preferably at least about 45 weight percent. Preferably the amount of filler (which in some instances may be considered a reinforcing agent) is 0.1 to about 65 weight percent, more preferably about 5 to about 50 weight percent.

It is preferred that the composition have a UL-94 rating of V-1 at a thickness of 0.79 mm, more preferably a UL-94 rating of V-0 at a thickness of 0.79 mm. The UL-94 test (Underwriter's Laboratories) is a flammability test for plastics materials, and the requirements for a V-0 rating are more stringent than those of a V-1 rating.

Preferably the composition has a Heat Deflection Temperature (HDT) at 1.82 MPa of at least about 240° C., more preferably at least about 275° C., and especially preferably at least about 340° C. The HDT is measured by ASTM Method D648.

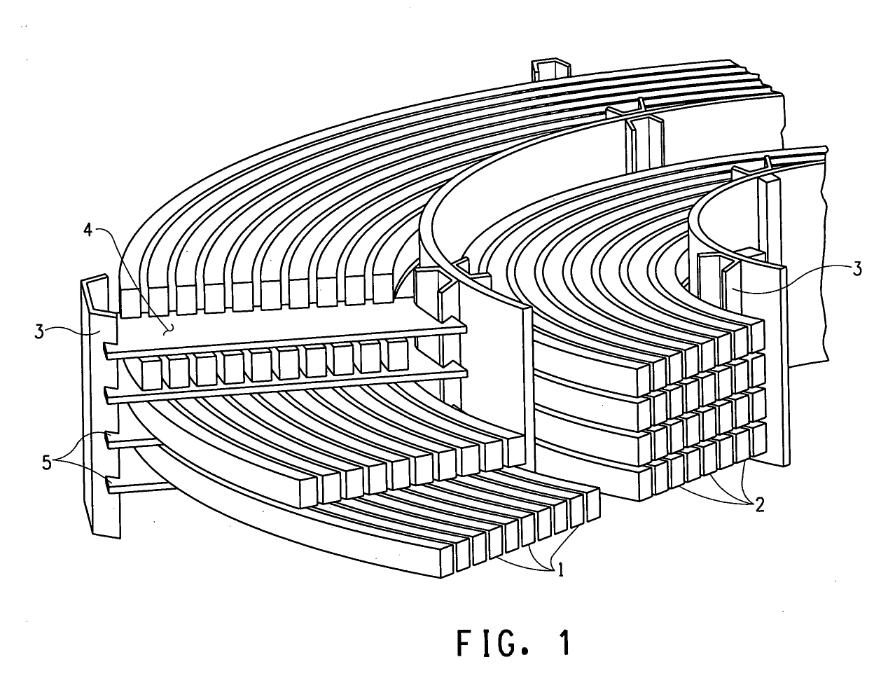

An example of a voltage transformer according to the invention is shown in FIG. 1. The transformer consists of high voltage coils (1) and low voltage coils (2) in separate compartments. The coils are made of conducting material such as copper. Vertical LCP spacers according to the invention (3) are designed to engage with horizontal LCP spacers according to the invention (4), by engaging tabs (5) at either end of the horizontal spacers. The horizontal spacers (4) fit horizontally between adjacent conducting coils.

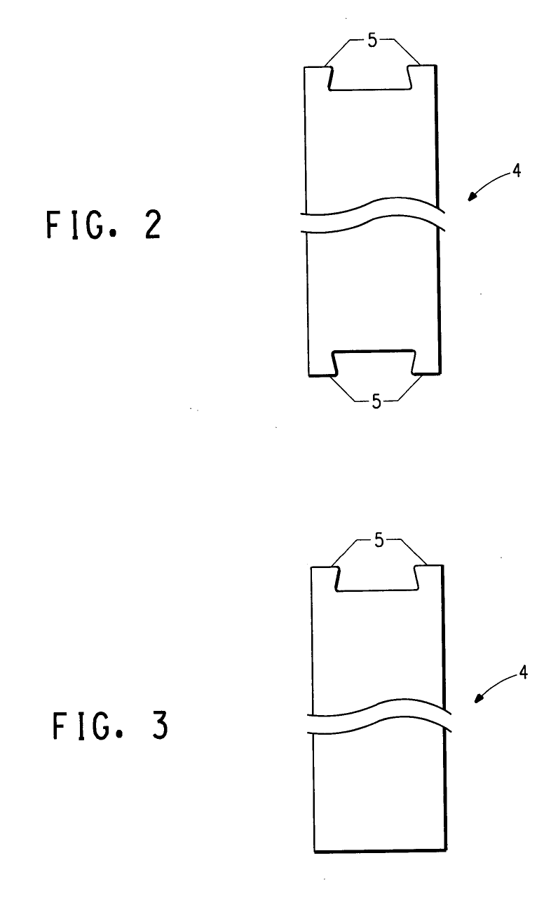

FIG. 2 shows the horizontal spacer (4), with tabs (5) at two ends. FIG. 3 shows a variation with tabs (5) at only one end. The tabs can be made in many variations, such as a “tee” shape “dogbone” shape or any other attachment shapes.

A transformer, as depicted in FIG. 1, can be built up as desired, by adding horizontal spacers (4) by clipping the tabs (5) onto the vertical spacers (3). In a preferred embodiment, horizontal spacers (4) are designed so that the tabs (5) have some degree of play when clipped into place on the vertical spacers (3). In this way the spacers (3) and (4) can accommodate changes in dimensions that can occur with temperature changes.

### EXAMPLE 1

Spacers according to the invention were injection moulded from an LCP made from 4,4′-biphenol/1,4-dihydroxybenzene/1,4-benzenedicarboxylic acid/2,6-naphthalenedicarboxylic acid/4-hydroxybenzoic acid (50/50/88/12/320 molar parts) and having a melting point of about 350° C.

Spacers of various dimensions and thicknesses were made. In this example spacers of dimensions 30×89 (Width×Length) were made in 1, 2 and 3.5 mm thicknesses. The spacers were tested for Electrical Strength according to International Standard IEC 60243-1. This method determines the voltage at which the material breaks down, and a discharge occurs. The results are normalised by dividing by the thickness of the spacer.

The spacers were placed between two electrodes, and the voltage between the electrodes was ramped rapidly until a discharge occurred. The voltage at which the discharge occurred was divided by the thickness of the spacer in mm, resulting in the dielectric strength, reported in V/mm.

The results of tests on spacers of 1 mm and 2 mm thicknesses are listed in Table 1 as the average of ten runs.

TABLE 1
Dielectric strength for spacers (AC rapid rise, per IEC 60243-1)

| Spacer material | Dielectric strength (kV/mm) |
|---|---|
| LCP (according to the invention) | 44.4 |
| thickness 1 mm | |
| LCP (according to the invention) | 33.2 |
| thickness 2 mm | |

It is clear that the LCP spacers of the invention have excellent dielectric strength.

1. A discrete spacer element used to separate and insulate the conducting coils of a transformer, wherein the spacer element is made of a liquid crystalline polymer (LCP).

2. The spacer element of claim 1 wherein the liquid crystalline polymer is liquid crystalline polyester.

3. The spacer element of claim 1, wherein the LCP is made from 4,4′-biphenol/1,4-dihydroxybenzene/1,4-benzenedicarboxylic acid/2,6-naphthalenedicarboxylic acid/4-hydroxybenzoic acid or derivatives thereof (50/50/88/12/320 molar parts) and has a melting point of about 350° C., and wherein the molar parts of 1,4-benzenedicarboxylic acid/2,6-naphthalenedicarboxylic acid range from about 70/30 to about 90/10, or wherein the LCP is made from 1,4-dihydroxybenzene/1,4-benzenedicarboxylic acid/2,6-naphthalenedicarboxylic acid/4-hydroxybenzoic acid or derivatives thereof (100/5/95/100 molar parts) and has a melting point of about 350° C., and wherein the molar parts of 1,4-benzenedicarboxylic acid/2,6-naphthalenedicarboxylic acid range from about 5/95 to about 30/70 and the molar parts of 4-hydroxybenzoic acid also range from about 100 to about 300.

4. The spacer element of claim 1, which has a sheet-like form.

5. The spacer element of claim 1, which has a rod-like form.

6. The spacer element of claim 1, which is made by injection moulding.

7. The spacer element of claim 1, which is made by extrusion.

8. An electrical transformer comprising:
electrical coils for stepping up, isolating and/or stepping down voltage, and discrete spacer elements separating and insulating the electrical coils, wherein the discrete spacer elements are made of a liquid crystalline polymer.

9. The electrical transformer of claim 8 herein the liquid crystalline polymer is liquid crystalline polyester.

10. The electrical transformer of claim 8, wherein the LCP is made from 4,4′-biphenol/1,4-dihydroxybenzene/1,4-benzenedicarboxylic acid/2,6-naphthalenedicarboxylic acid/4-hydroxybenzoic acid or derivatives thereof (50/50/88/12/320 molar parts) and has a melting point of about 350° C., and wherein the molar parts of 1,4-benzenedicarboxylic acid/2,6-naphthalenedicarboxylic acid range from about 70/30 to about 90/10, or wherein the LCP is made from 1,4-dihydroxybenzene/1,4-benzenedicarboxylic acid/2,6-naphthalenedicarboxylic acid/4-hydroxybenzoic acid or derivatives thereof (100/5/95/100 molar parts) and has a melting point of about 350° C., and wherein the molar parts of 1,4-benzenedicarboxylic acid/2,6-naphthalenedicarboxylic acid range from about 5/95 to about 30/70 and the molar parts of 4-hydroxybenzoic acid also range from about 100 to about 300.

11. The electrical transformer of claim 8, wherein the spacer element has a sheet-like form.

12. The electrical transformer of claim 8, wherein the spacer element has a rod-like form.

13. The electrical transformer of claim 8, wherein the spacer elements are made by injection moulding.

14. The electrical transformer of claim 8, wherein the spacer elements are made by extrusion.

15. A process for making an insulating spacer element for an electrical transformer, comprising injection-moulding or extruding an LCP into the desired form.

16. The process of claim 15, wherein the LCP is made from 4,4′-biphenol/1,4-dihydroxybenzene/1,4-benzenedicarboxylic acid/2,6-naphthalenedicarboxylic acid/4-hydroxybenzoic acid or derivatives thereof (50/50/88/12/320 molar parts) and has a melting point of about 350° C., and wherein the molar parts of 1,4-benzenedicarboxylic acid/2,6-naphthalenedicarboxylic acid range from about 70/30 to about 90/10, or wherein the LCP is made from 1,4-dihydroxybenzene/1,4-benzenedicarboxylic acid/2,6-naphthalenedicarboxylic acid/4-hydroxybenzoic acid or derivatives thereof (100/5/95/100 molar parts) and has a melting point of about 350° C., and wherein the molar parts of 1,4-benzenedicarboxylic acid/2,6-naphthalenedicarboxylic acid range from about 5/95 to about 30/70 and the molar parts of 4-hydroxybenzoic acid also range from about 100 to about 300.

17. The process of claim 15, wherein the spacer has a sheet-like form.

18. The process of claim 15, wherein the spacer has a rod-like form.

19. A process for making an electrical transformer, comprising the step of:
inserting an insulating spacer made of LCP between coils of conducting wire.

20. The process of claim 19, wherein the LCP is made from 4,4′-biphenol/1,4-dihydroxybenzene/1,4-benzenedicarboxylic acid/2,6-naphthalenedicarboxylic acid/4-hydroxybenzoic acid or derivatives thereof (50/50/88/12/320 molar parts) and has a melting point of about 350° C., and wherein the molar parts of 1,4-benzenedicarboxylic acid/2,6-naphthalenedicarboxylic acid range from about 70/30 to about 90/10, or wherein the LCP is made from 1,4-dihydroxybenzene/1,4-benzenedicarboxylic acid/2,6-naphthalenedicarboxylic acid/4-hydroxybenzoic acid or derivatives thereof (100/5/95/100 molar parts) and has a melting point of about 350° C., and wherein the molar parts of 1,4-benzenedicarboxylic acid/2,6-naphthalenedicarboxylic acid range from about 5/95 to about 30/70 and the molar parts of 4-hydroxybenzoic acid also range from about 100 to about 300.

21. The process of claim 19, wherein the spacer element has a sheet-like form.

22. The process of claim 19, wherein the spacer element has a rod-like form.

23. The process of claim 19, wherein the spacer element is made by injection moulding.

24. The process of claim 19, wherein the spacer element is made by extrusion.
